(19) United States
(12) Patent Application Publication
(10) Pub. No.: US 2014/0023223 A1
(43) Pub. Date: Jan. 23, 2014

(54) BODY INCLUDING A RECEIVING UNIT FOR A SPEAKER, AND A TERMINAL INCLUDING THE BODY

(71) Applicants: Yun Ho HWANG, Seoul (KR); Ju Yeol Pyo, Seoul (KR); Hyun Duk Roh, Seoul (KR)

(72) Inventors: Yun Ho HWANG, Seoul (KR); Ju Yeol Pyo, Seoul (KR); Hyun Duk Roh, Seoul (KR)

(73) Assignee: PANTECH CO., LTD., Seoul (KR)

(21) Appl. No.: 13/942,123

(22) Filed: Jul. 15, 2013

(30) Foreign Application Priority Data
Jul. 17, 2012 (KR) 10-2012-0077603

(51) Int. Cl. H04R 1/02

(52) U.S. Cl. CPC H04R 1/025
USPC 381/386

(57) ABSTRACT

Provided is a terminal including: a speaker; a body including a receiving unit to receive the speaker; a cover disposed over the receiving unit to cover the speaker, and a space disposed between the speaker and the cover.

### CROSS-REFERENCE TO RELATED APPLICATION

This application claims priority from and the benefit under 35 U.S.C. § 119(a) of Korean Patent Application No. 10-2012-0077603, filed on Jul. 17, 2012, which is hereby incorporated by reference for all purposes as if fully set forth herein.

### BACKGROUND

1. Field

Exemplary embodiments of the present invention relate to a terminal including a speaker, and more particularly, to a terminal including a speaker that includes a space partitioned to secure a sound quality of the speaker using a decreased structure, thereby increasing space utilization and reducing a size of the terminal, simultaneously.

2. Discussion of the Background

Electronic devices are gradually being diversified with development of information and communications technology. Such diversification of the electronic devices is predominant in fixed electronic devices and portable terminals corresponding to mobile electronic devices. The portable terminals having already gained popularity may include, for example, a cellular phone, a Moving Picture Experts Group (MPEG) Audio Layer 3 (MP3) player, a digital camera, a portable multimedia player (PMP), a navigation system, a portable game console, an electronic dictionary, an electronic book reader, a digital multimedia broadcasting (DMB) receiver, and the like. Recently, portable terminals, for example, a smart phone, a tablet computer, a smart pad, and the like, have been newly introduced and thus, related industries are expanding rapidly.

A terminal generally includes a speaker installed in a partitioned space having a volume sufficient for reproducing a low-pitched sound. In order to block an offset of front and back sound to be generated, the speaker may be disposed in an internal portion between an upper housing and a lower housing that are coupled to each other to provide the partitioned space, and may then be installed in the terminal. Obtaining a sufficient volume in the internal portion of the housing may be needed to secure a sound quality of the speaker. Accordingly, reducing the volume of the housing to be less than a predetermined size may be difficult. Such a difficulty may be one of the obstacles to reducing a size of the terminal.

### SUMMARY

According to exemplary embodiments, there is provided a terminal including: a speaker; a body including a receiving unit to receive the speaker; a cover disposed over the receiving unit to cover the speaker, and a space disposed between the speaker and the cover.

According to exemplary embodiments, there is provided a body for use in a mobile terminal, the body including: an exterior wall; a receiving unit configured to receive a speaker; a cover disposed over the receiving unit to cover the speaker, and a space disposed between the speaker and the cover in the receiving unit, wherein the space is disposed between speaker and the exterior wall.

Additional features of the invention will be set forth in the description that follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an exploded perspective view of a terminal including a speaker according to exemplary embodiments of the present invention.

FIG. 2 illustrates a cross-sectional view of the terminal of FIG. 1.

FIG. 3 illustrates a cross-sectional view of a cover integrally formed with a speaker according to exemplary embodiments of the present invention.

FIG. 4 illustrates a cross-sectional view of a first cover integrally formed with a second cover according to exemplary embodiments of the present invention.

FIG. 5 illustrates a cross-sectional view of a body integrally formed with a speaker according to exemplary embodiments of the present invention.

FIG. 6 illustrates a cross-sectional view of a terminal including a speaker according to exemplary embodiments of the present invention.

FIG. 7 illustrates a cross-sectional view of a terminal including a speaker according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

It will be understood that when an element is referred to as being “connected to” another element, it can be directly connected to the other element, or intervening elements may be present.

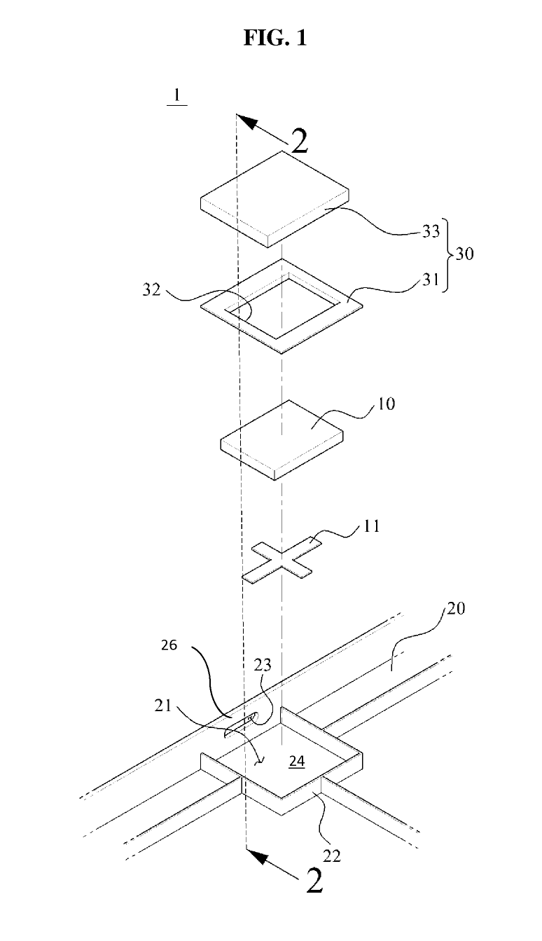

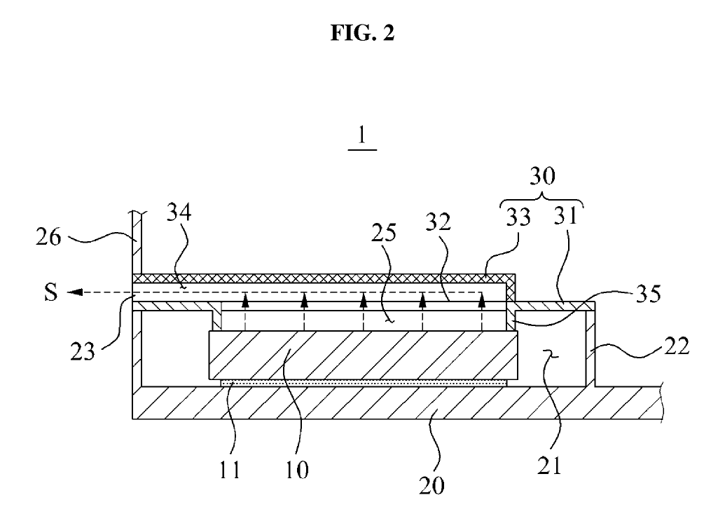

FIG. 1 illustrates an exploded perspective view of a terminal including a speaker according to exemplary embodiments of the present invention. FIG. 2 illustrates a cross-sectional view of the terminal of FIG. 1.

Referring to FIGS. 1 and 2, a terminal 1 may include a speaker 10, a body 20, and a cover 30.

The speaker 10 may convert an electronic sound signal into a sound S (illustrated in FIG. 2). The speaker 10 may correspond to a small-sized speaker that may be disposed in the terminal 1. The speaker 10 may be understood based on publicly known technology and thus, detailed description will be omitted herein.

The body 20 may correspond to a body of the terminal 1, and may include a receiving unit 21 that is integrally formed in the body 20 to receive the speaker 10. Although not shown in detail, in general, the terminal 1 may include a front case forming a front surface of the terminal 1 and supporting a display module, a middle case which is coupled to the front case and in which various parts are to be mounted, a rear case coupled to the middle case to cover the mounted parts, a back cover coupled to the rear case to cover a battery, and the like. Although the body 20 of the terminal 1 may correspond to the rear case, the body 20 is not limited thereto.

For example, in some embodiments the body 20, including the receiving unit 21 configured to receive the speaker 10, may be installed in one of the front case or the middle case.

The receiving unit 21 may include a support rib 22 protruding and extending toward an internal portion of the terminal 1. The support rib 22 may be formed to integrally extend or protrude from an inner surface 24 of the body 20. The support rib 22 may be formed to protrude (extend) from the inner surface 24 of the body 20 so that the receiving unit 21 corresponding to a shape of the speaker 10 may be formed. In FIGS. 1 and 2, the support rib 22 may protrude from the inner surface 24 of the body 20 and the receiving unit 21 may have a volume of a rough hexahedron along with a side surface of the body 20. A protrusion height or depth of the support rib 22 may be sufficient to mount, couple to, encapsulate, compartmentalize or otherwise support the speaker 10.

A buffering member 11 can be disposed or installed between the body 20 and the speaker 10 to buffer an external shock. The buffering member 11 may be formed of a cushioning material, for example, a sponge that has an elasticity to buffer an external force without interfering in generation of the sound S of the speaker 10. The buffering member 11 may be bonded to the body 20 and the speaker 10 by an adhesive (not shown), for example, a double-sided tape, an adhesive, and the like. A shape of the at least one buffering member 11 is not limited to the exemplary embodiment of FIG. 1. In some embodiments, the buffering member 11 can be an adhesive, thus eliminating the need for a separate adhesive. In some embodiments, the adhesive can be disposed on the inner surface 24.

A cover 30 may cover the speaker 10 installed in the receiving unit 21. The cover 30 may separate the speaker from the body 20 and protect the speaker 10. The cover 30 may block a leakage of the sound S generated by the speaker 10 in an undesired direction.

FIG. 2 illustrates the cover 30 coupled to the receiving unit 21 of the body 20. A space 25 may be formed between the speaker 10 and the body 20 within the receiving unit 21. The space 25 excluding the speaker 10 within the receiving unit 21 may correspond to a space for securing a sound quality of the sound S generated by the speaker 10. The space 25 may have a further effect of increasing a sound quality at a low register as more space is obtained or defined within the receiving unit 21. When the speaker 10 is received in the receiving unit 21 and covered by the cover 30, rather than being solely installed in the internal portion of the body 20, a space for a resonance of the sound S may be obtained within the limited internal volume of the terminal 1. The increase in sound quality can be obtained simultaneously with a reduction in size of the terminal 10.

The cover 30 may include a first cover 31 and a second cover 33.

The first cover 31 may be coupled to the body 20 in a direction facing the body 20 in which the speaker 10 is received. The first cover 31 may include a void or a sound hole 32 through which the sound S generated by the speaker 10 is emitted. As shown in FIG. 2, the first cover 31 may be coupled to the support rib 22 protruding from the body 20 to primarily cover the speaker 10 installed in the receiving unit 21.

The second cover 33 may overlay the sound hole 32 of the first cover 31. The second cover 33 may be include an area greater than an area of the sound hole 32 included in the first cover 31. The second cover 32 may define or form a guide flow path 34. Guide flow path can communicate with the sound hole 32 and guide a direction of the sound S. The second cover 33 may cover the speaker 10 installed in the receiving unit 21. The guide flow path 34 formed by the second cover 33 may communicate with a sound outlet 23 formed on a sidewall 26 of the receiving unit 21. The sound outlet 23 can penetrate the body 20, such that the sound S generated by the speaker 10 may be emitted external to the terminal 1. The guide flow path 34 can direct a sound from the speaker 10, for example, laterally. The first cover 31, speaker 10 and second cover 33 can define a guide path 34 for the sound and the sound outlet 23 can be disposed laterally offset from the speaker 10. For example, sound S generated by speaker 10 can travel from the sound hole 32 along the guide flow path 34, and out from the sound outlet 23. Sidewall 26 can include a portion of the body 20. In some embodiments, sidewall 26 can include a support rib 22. A shape of the second cover 33 is not limited to a horizontal shape, as shown in FIGS. 1 and 2. In some embodiments, the second cover 33 can have an inclined shape and provide a guide flow path (not shown) that is narrower proximate the speaker 10, and wider proximate the sound outlet 23. The second cover 33 can include a protrusion 35 to secure the speaker 10 in the receiving unit 11. The protrusion 35 can include a wall extending from the second cover 33. In some embodiments, the protrusion 35 can include a ridge, a crest, an elevation, a pucker, or the like. For reference, the first cover 31 may include a protrusion (not shown) to secure the speaker 10 in the receiving unit 11.

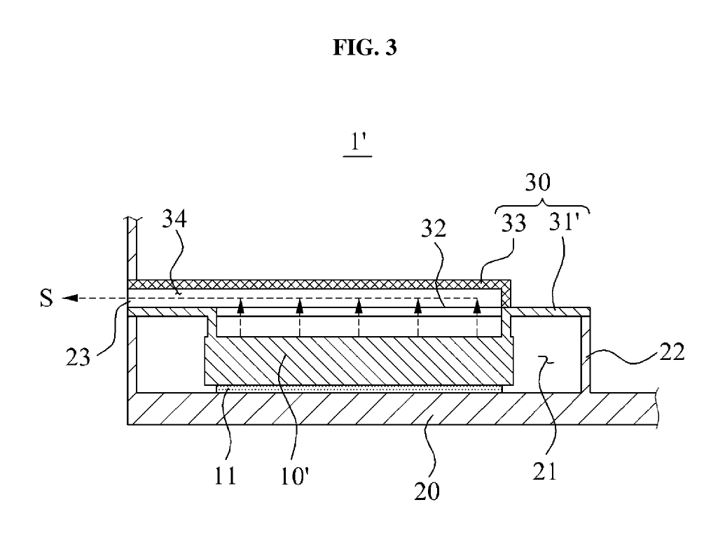

The first cover 31 and the second cover 33 are not limited to the exemplary embodiments of FIGS. 1 and 2. FIG. 3 illustrates a cross-sectional view of a cover integrally formed with a speaker according to exemplary embodiments of the present invention. Terminal 1′ may include a first cover 31′ and a speaker 10′, integrally formed, and coupled or affixed to the support rib 22 of the body 20. The first cover 31′, speaker 10 and second cover 33′ can define a guide path 34 for the sound and the sound outlet 23 can be disposed laterally offset from the speaker 10.

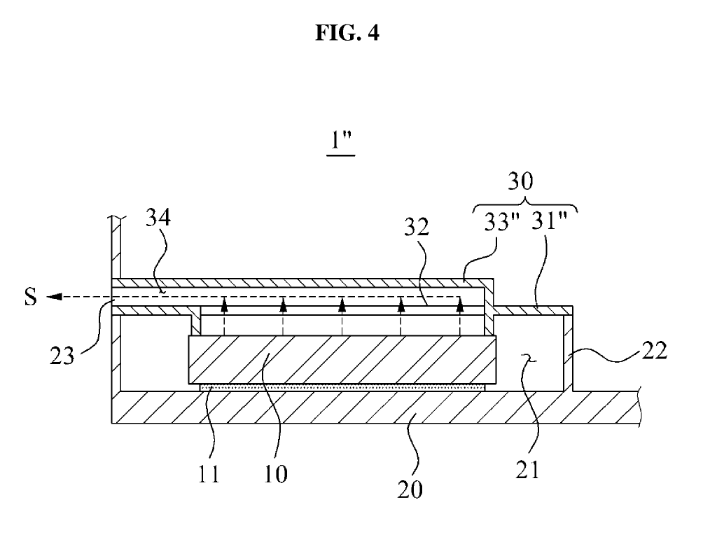

FIG. 4 illustrates a cross-sectional view of a first cover integrally formed with a second cover according to exemplary embodiments of the present invention. A terminal 1″ may include a first cover 31″ and a second cover 33″, integrally formed, and coupled or affixed, to the support rib 22 to cover the speaker 10 received in the receiving unit 21. The first cover 31″, speaker 10 and second cover 33″ can define a guide path 34 for the sound and the sound outlet 23 can be disposed laterally offset from the speaker 10.

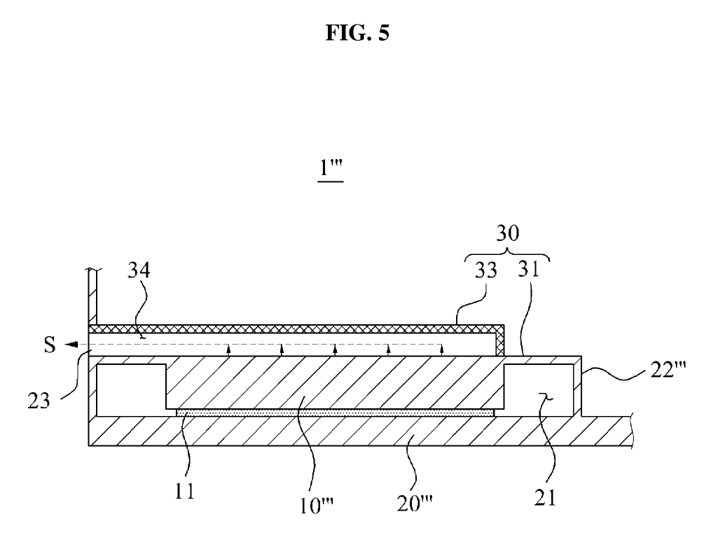

FIG. 5 illustrates a cross-sectional view of a body integrally formed with a speaker according to exemplary embodiments of the present invention. A terminal 1′″ can include a speaker 10′″ and a body 20′″ that may be integrally formed. The speaker 10 and the second cover 33 can define a guide path 34 for the sound and the sound outlet 23 can be disposed laterally offset from the speaker 10. In FIG. 5, a support rib 22′″ of the body 20′″ may be integrally formed with the speaker 10′″. The modified example of FIGS. 3 through 5 may correspond to various modifications that may reduce a size of a terminal, and may also obtain a space for securing a sound quality of each speaker 10, 10′, 10′″ or 10′″, respectively.

As shown in FIGS. 1 and 2, the speaker 10 may be installed with a buffering member 11 in the receiving unit 21 formed by the support rib 22 of the body 20. The first cover 31 and the second cover 33 of the cover 30 may cover the speaker 10 installed in the receiving unit 21, sequentially. When the sound S is generated by the speaker 10, the sound S may be guided through the sound hole 32 of the first cover 31 facing the speaker 10, and may continuously be guided along the guide flow path 34 formed by the second cover 33 intercommunicating with the sound hole 32. The guide flow path 34 may communicate with the sound outlet 23 disposed on the side surface 26 of the body 20 such that the sound S may finally be provided to the external portion of the terminal 1 through the sound outlet 23.

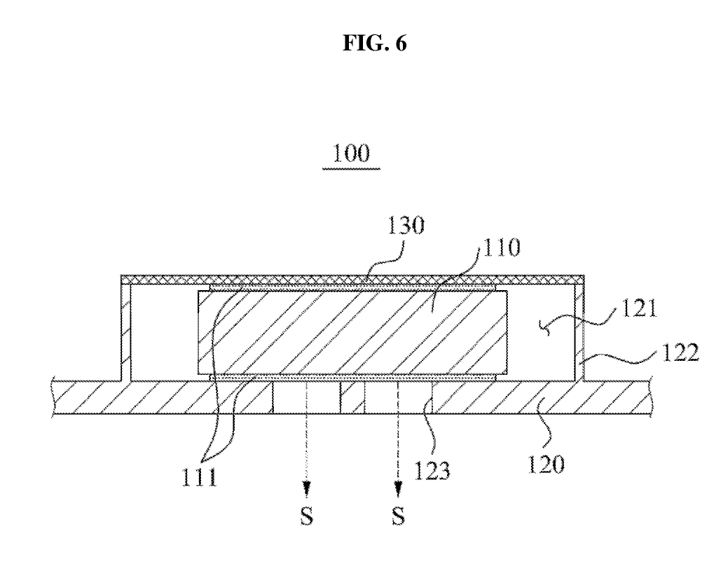

FIG. 6 illustrates a cross-sectional view of a terminal including a speaker according to exemplary embodiments of the present invention. The terminal 100 may include a speaker 110, a body 120, and a cover 130. The speaker 110 may generate a sound S, and may be installed in a receiving unit 121 of the body 120. The body 120 may correspond to a body of the terminal 100. The body 120 may include a rear case, but is not limited thereto. The body 120 may include a protruding support rib 122 in an inner surface to define a portion of the receiving unit 121 in which the speaker 110 is to be received. The configuration of the body 120 may be similar to the body 20 described with reference to FIGS. 1 and 2 and thus, a detailed description will be omitted herein.

The speaker 110 may transfer the generated sound S directly to the body 120 facing the speaker 110, thereby emitting the sound S to an external portion of the terminal 100. To emit the sound S to the external portion of the terminal 100, the body 120 may include at least one sound outlet 123 formed to penetrate the body 120, in a location at which the body 120 faces the speaker 110.

The cover 130 may cover the speaker 110 installed in the receiving unit 121.

Unlike the cover 30 described with reference to FIGS. 1 and 2, the cover 130 may not be classified into the first cover 31 and the second cover 33 and thus, the guide flow path 34 of FIG. 2 to guide the direction in which the sound S is to be emitted may not be formed. For example, the sound S generated by the speaker 110 may be emitted directly to the external portion of the terminal 100 through the at least one sound outlet 123 of the body 120. Accordingly, the cover 130 may not need a structure for guiding the emission of the sound S.

Buffering members 111 for buffering an external shock may be disposed between the body 120 and the speaker 110, and between the speaker 110 and the cover 130. A count of buffering members 111 may vary depending on exemplary embodiments. The material and configuration of the buffering member 111 can include an adhesive identical to the material and the configuration of the buffering member 11 described with reference to FIGS. 1 and 2. External shock to the speaker 110 may be buffered by the buffering members 111 even though the speaker 110 is closely installed in a space between the body 120 and the cover 130. When the speaker 110 is installed in the receiving unit 120 of FIG. 6, a space between the speaker 110 and the body 120 may be provided, for example, by the buffering member 111, to secure a better sound quality.

In the terminal 100, the speaker 110 may be installed in the receiving unit 121 formed in-part by the support rib 122 of the body 120, and may then be covered by the cover 130. When the speaker 110 receives a sound signal and generates the sound S, the generated sound S may be emitted to the external portion of the terminal 100 through the at least one sound outlet 123 of the body 120. The speaker 110, the body 120, and the cover 130 of the terminal 100 may be formed individually.

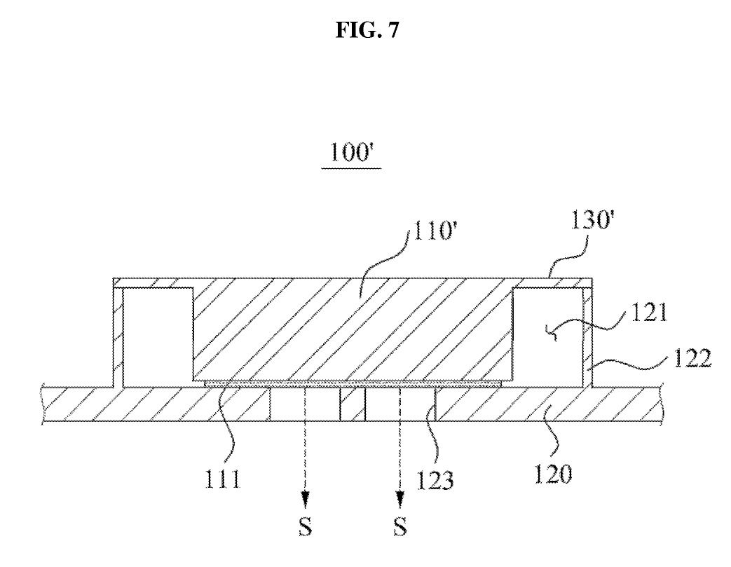

FIG. 7 illustrates a cross-sectional view of a terminal including a speaker according to exemplary embodiments of the present invention. A terminal 100′ can include an integrally formed speaker 110′ and cover 130′. The integrally formed speaker 110′ and cover 130′may be coupled or affixed to a support rib 122′, as shown in FIG. 7. The count of sound outlets 123 is not limited to the exemplary embodiments of FIGS. 6 and 7. The count of the sound outlets 123 may be changed variously in view of a size and performance of the terminal 100, and the like.

According to exemplary embodiments of the present invention, there is provided a terminal including a speaker that is installed directly in a receiving unit formed in a body such that an existing housing used to install the speaker may become unnecessary and thus, space utilization may be increased.

According to exemplary embodiments of the present invention, a speaker installed directly in a body may increase space utilization, thereby reducing a size of a terminal.

According to exemplary embodiments of the present invention, a space having a volume sufficient for increasing a performance at a low register may be obtained and thus, a sound quality at a low register may be increased.

Although a few exemplary embodiments of the present invention have been shown and described, the present invention is not limited to the described exemplary embodiments. Instead, it will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal comprising:
a speaker;
a body comprising a receiving unit to receive the speaker;
a cover disposed over the receiving unit to cover the speaker; and
a space disposed between the speaker and the cover.

2. The terminal of claim 1, wherein the receiving unit comprises a wall extending from the body.

3. The terminal of claim 1, wherein the receiving unit comprises an exterior wall of the body.

4. The terminal of claim 1, further comprising a buffering member disposed between the receiving unit and the speaker.

5. The terminal of claim 1, further comprising a buffering member disposed between the receiving unit and the cover, and wherein the buffering member is disposed in the space.

6. The terminal of claim 1, further comprising a void disposed between the speaker and the cover, and wherein the space comprises the void.

7. The terminal of claim 1 further comprising:
a sound outlet disposed in the body, wherein the sound outlet communicates a speaker sound to an exterior of the body via the space.

8. The terminal of claim 7, wherein the speaker and the cover define a sound guide path and the sound outlet is disposed laterally offset from the speaker.

9. The terminal of claim 1, wherein the cover comprises a first cover comprising a sound hole and a second cover to cover the sound hole and a sound guide path is defined between the first cover and the second cover.

10. The terminal of claim 9, wherein the first cover and the second cover are formed as a unitary construction.

11. The terminal of claim 1, wherein the receiving unit and the speaker are formed as a unitary construction.

12. The terminal of claim 1, wherein the body and receiving unit are formed as unitary construction.

13. A body for use in a mobile terminal, the body comprising:
an exterior wall;
a receiving unit configured to receive a speaker;
a cover disposed over the receiving unit to cover the speaker; and
a space disposed between the speaker and the cover,
wherein the space is disposed between the speaker and the exterior wall.

14. The body of claim 13, wherein the receiving unit comprises a wall extending from the body.

15. The body of claim 13, wherein the receiving unit comprises a portion of the exterior wall.

16. The body of claim 13, further comprising a void disposed between the speaker and the cover, and wherein the space comprises the void.

17. The body of claim 13, further comprising:
a sound outlet disposed on the exterior wall, wherein the sound outlet communicates a speaker sound to an exterior of the body via the space.

18. The body of claim 13, wherein the speaker and the cover define a sound guide path and the sound outlet is disposed laterally offset from the speaker.

19. The body of claim 13, wherein the cover comprises a first cover comprising a sound hole and a second cover to cover the sound hole and a sound guide path is defined between the first cover and the second cover.

20. The body of claim 13, wherein the body and receiving unit are formed as unitary construction.
